(19) United States
(12) Patent Application Publication
(10) Pub. No.: US 2023/0030758 A1
(43) Pub. Date: Feb. 2, 2023

(54) METHOD AND DEVICE IN NODES USED FOR WIRELESS COMMUNICATION

(71) Applicants: Jin LIU, SHANGHAI (CN); Xiaobo ZHANG, SHANGHAI (CN)

(72) Inventors: Jin LIU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/963,182

(22) Filed: Oct. 10, 2022

Related U.S. Application Data
(63) Continuation of application No. PCT/CN2021/087656, filed on Apr. 16, 2021.

(30) Foreign Application Priority Data
Apr. 23, 2020 (CN) 202010325560.X

(51) Int. Cl. H04B 7/06; H04L 5/00; H04W 24/10

(52) U.S. Cl. CPC H04B 7/0626; H04L 5/0051; H04W 24/10

(57) ABSTRACT

Disclosure a method and device in nodes used for wireless communications. A first receiver receives Q reference signals, Q being a positive integer greater than 1; and transmits a first signal, the first signal comprises a first CSI; among the Q reference signals, only a measurement performed on a first reference signal is used to calculate the first CSI; a type of the first signal is used to determine the first reference signal out of the Q reference signals; when the type of the first signal is the first candidate type, the first signal comprises only a CSI corresponding to a target receiver of the first signal; when the type of the first signal is the second candidate type, the first signal comprises CSIs corresponding to at least two target receivers of the first signal. The present application optimizes resource utilization efficiency of reporting of sidelink Channel State Information (CSI).

### CROSS REFERENCE TO RELATED APPLICATIONS

This application is the continuation of the International patent application No. PCT/CN2021/087656, filed on Apr. 16, 2021, which claims the priority benefit of Chinese Patent Application No. 202010325560.X, filed on Apr. 23, 2020, the full disclosure of which is incorporated herein by reference.

### BACKGROUND

### Technical Field

The present application relates to transmission methods and devices in wireless communication systems, and in particular to a sidelink-related transmission scheme and device in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize the NR.

In response to rapidly growing Vehicle-to-Everything (V2X) traffic, 3GPP has started standards setting and research work under the framework of NR. Currently, 3GPP has completed planning work targeting 5G V2X requirements and has included these requirements into standard TS22.886, where 3GPP identifies and defines 4 major Use Case Groups, covering cases of Vehicles Platooning, supporting Extended Sensors, Advanced Driving and Remote Driving. Besides, 3GPP RAN #80 plenary has started an NR-based V2X technical research.

### SUMMARY

In NR V2X system, a Tx UE transmits a Channel State Information-Reference Signal (CSI-RS) in a Physical Sidelink Shared Channel (PSSCH) to acquire channel quality on Sidelink (SL), and a measurement performed by an Rx UE on the CSI-RS is used to calculate Channel State Information (CSI) of SL and then the CSI is reported to the Tx UE. Currently, the CSI reporting is non-periodic, that is, once the CSI-RS is transmitted, the CSI reporting is triggered only once, and the CSI-RS only occurs on a unicast PSSCH. The CSI reporting is also unicast, that is, the Rx UE only reports a CSI corresponding one CSI-RS at a time. Since a minimum resource unit of an SL transmission is subchannel, the signaling overhead of the CSI only occupies a small part of resources compared with the subchannel, while other subchannel resources are wasted. In addition, the Rx UE needs to sense a block of SL resources to perform the CSI reporting, which leads to extremely inefficient utilization of resources reported by CSI.

To solve the above problem, the present application discloses a multi-CSI reporting mechanism, which determines a bearing mode of multiple CSIs through a type of a first signal, thus ensuring the utilization efficiency of resources of the CSI reporting. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict. Though originally targeted at SL, the present application is also applicable to uplink (UL). Though originally targeted at single-carrier communications, the present application is also applicable to multicarrier communications. Though originally targeted at single-antenna communications, the present application is also applicable to multi-antenna communications. Besides, the present application is not only targeted at scenarios of V2X scenarios, but also at communication scenarios between a terminal and a base station, a terminal and a relay as well as a relay and base station where similar technical effect can be achieved. Additionally, the adoption of a unified solution for various scenarios, including but not limited to V2X scenarios and communication scenarios between a terminal and a base station, contributes to the reduction of hardware complexity and costs.

It should be noted that interpretations of the terminology in the present application refer to definitions given in the 3GPP TS36 series, TS37 series, TS38 series, as well as definitions given in Institute of Electrical and Electronics Engineers (IEEE) protocol specifications.

The present application provides a method in a first node for wireless communications, comprising:

receiving Q reference signals, Q being a positive integer greater than 1; and

transmitting a first signal, the first signal comprising first Channel State Information (CSI);

herein, among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, a problem to be solved in the present application is resource utilization efficiency problem of the CSI reporting of NR V2X system.

In one embodiment, a method in the present application is introducing multiple CSI reportings on SL.

In one embodiment, a method in the present application is: multiple reported CSIs are for multiple CSI-RSs of a Tx UE, or, multiple reported CSIs are for CSI-RSs of multiple Tx UEs.

In one embodiment, a method in the present application is: a type of the first signal is used to determine which of multiple CSI-RSs a reported CSI is for.

In one embodiment, the above method is characterized in that a PSSCH carrying a CSI-RS is unicast, and a PSSCH reporting a CSI can be one of Unicast, Groupcast or Broadcast, that is, a PSSCH transmission between a Tx UE and an Rx UE is asymmetric.

In one embodiment, the above method is characterized in that multiple CSIs are introduced on SL, and which of multiple CSI-RSs a reported CSI is for is implicitly indicated through a signal type of the CSI reporting.

In one embodiment, the above method is advantageous in that the resource utilization efficiency of the CSI reporting is optimized.

According to one aspect of the present application, the above method is characterized in comprising:

transmitting a first signaling;

herein, the first signaling indicates the type of the first signal.

According to one aspect of the present application, the above method is characterized in that when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

According to one aspect of the present application, the above method is characterized in that when the type of the first signal is the first candidate type, the first signaling indicates the first reference signal.

According to one aspect of the present application, the above method is characterized in that when the type of the first signal is the first candidate type, the first signal comprises a series of Q CSIs; measurements corresponding to the Q reference signals are respectively used to calculate the series of Q CSIs, and the first CSI is not the last CSI among the series of Q CSIs.

According to one aspect of the present application, the above method is characterized in comprising:

transmitting a second signaling;

herein, when the type of the first signal is the second candidate type, the first signal comprises a series of M CSIs, M being a positive integer greater than 1; the Q reference signals are transmitted by a second node; the second signaling indicates an index m of a CSI corresponding to the second node in the first signal; the first CSI is an m-th CSI among the series of M CSIs.

According to one aspect of the present application, the above method is characterized in that the first node is a UE.

According to one aspect of the present application, the above method is characterized in that the first node is a relay node.

According to one aspect of the present application, the above method is characterized in that the first node is a base station.

The present application provides a method in a second node for wireless communications, comprising:

transmitting Q reference signals, Q being a positive integer greater than 1; and

receiving a first signal, the first signal comprising a first CSI;

herein, among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

According to one aspect of the present application, the above method is characterized in comprising:

receiving a first signaling; herein, the first signaling indicates the type of the first signal.

According to one aspect of the present application, the above method is characterized in that when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

According to one aspect of the present application, the above method is characterized in that when the type of the first signal is the first candidate type, the first signaling indicates the first reference signal.

According to one aspect of the present application, the above method is characterized in that when the type of the first signal is the first candidate type, the first signal comprises a series of Q CSIs; measurements corresponding to the Q reference signals are respectively used to calculate the series of Q CSIs, and the first CSI is not the last CSI among the series of Q CSIs.

According to one aspect of the present application, the above method is characterized in comprising:

receiving a second signaling;

herein, when the type of the first signal is the second candidate type, the first signal comprises a series of M CSIs, M being a positive integer greater than 1; the Q reference signals are transmitted by a second node; the second signaling indicates an index m of a CSI corresponding to the second node in the first signal; the first CSI is an m-th CSI among the series of M CSIs.

According to one aspect of the present application, the above method is characterized in that the second node is a UE.

According to one aspect of the present application, the above method is characterized in that the second node is a relay node.

According to one aspect of the present application, the above method is characterized in that the second node is a base station.

The present application provides a first node for wireless communications, comprising:

a first receiver, receiving Q reference signals, Q being a positive integer greater than 1; and

a first transmitter, transmitting a first signal, the first signal comprising a first CSI;

herein, among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

The present application provides a second node for wireless communications, comprising:

a second transmitter, transmitting Q reference signals, Q being a positive integer greater than 1; and

a second receiver, receiving a first signal, the first signal comprising a first CSI;

herein, among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, the present application is advantageous in the following aspects:

a problem to be solved in the present application is resource utilization efficiency problem of the CSI reporting of NR V2X system;
the present application introduces multiple CSI reportings on SL;
in the present application, multiple reported CSIs are for multiple CSI-RSs of a Tx UE, or, multiple reported CSIs are for CSI-RSs of multiple Tx UEs;
the present application determines which of multiple CSI-RSs a reported CSI is for through a type of the first signal;
in the present application, a PSSCH carrying a CSI-RS is Unicast, and a PSSCH reporting a CSI can be one of Unicast, Groupcast or Broadcast, that is, a PSSCH transmission between a Tx UE and an Rx UE is asymmetric;
the present application optimizes the utilization efficiency of SL resources of the CSI reporting.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of relations among Q reference signals and a first signal according to one embodiment of the present application;

FIG. 7 illustrates a schematic diagram of a relation between a first CSI and a first signal according to one embodiment of the present application;

FIG. 8 illustrates a structure block diagram of a processor in a first node according to one embodiment of the present application;

FIG. 9 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of the processing of a first node according to one embodiment of the present application, as shown in FIG. 1. In FIG. 1, each block represents a step.

In Embodiment 1, a first node in the present application first receives Q reference signals in step 101; the transmits a first signal in step 102; the first signal comprises a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal; Q is a positive integer greater than 1.

In one embodiment, transmitters of the Q reference signals are a same communication node.

In one embodiment, transmitters of the Q reference signals are a same UE.

In one embodiment, transmitters of the Q reference signals are a same base station.

In one embodiment, time-domain resources occupied by any two of the Q reference signals are orthogonal (i.e., there is no overlapping).

In one embodiment, at least two of the Q reference signals are Time Division Multiplexing (TDM).

In one embodiment, at least two of the Q reference signals are Frequency Division Multiplexing (FDM).

In one embodiment, at least two of the Q reference signals are Code Division Multiplexing (CDM).

In one embodiment, the Q reference signals respectively comprise Q first-type sequences, Q being a positive integer greater than 1.

In one embodiment, Q first-type sequences are respectively used to generate the Q reference signals, Q being a positive integer greater than 1.

In one embodiment, any of the Q first-type sequences is a Pseudo-Random Sequence.

In one embodiment, any of the Q first-type sequences is a Low-Peak to Average Power Ratio (Low-PAPR) sequence.

In one embodiment, any of the Q first-type sequences is a Gold sequence.

In one embodiment, any of the Q first-type sequences is an M sequence.

In one embodiment, any of the Q first-type sequences is a Zadeoff-Chu (ZC) sequence.

In one embodiment, the Q reference signals are acquired after the Q first-type sequences respectively through Sequence Generation, Discrete Fourier Transform, Modulation and Resource Element Mapping, as well as wideband symbol generation.

In one embodiment, any of the Q first-type sequences is mapped onto a positive integer number of Resource Element(s) (RE(s)).

In one embodiment, the Q reference signals comprise a positive integer number of Reference Signal(s) (RS(s)).

In one embodiment, the Q reference signals comprise a positive integer number of Channel State Information-Reference Signal(s) (CSI-RS(s)).

In one embodiment, the Q reference signals comprise a zero-power CSI-RS.

In one embodiment, the Q reference signals comprise a non-zero-power CSI-RS.

In one embodiment, the Q reference signals are respectively Q CSI-RSs.

In one embodiment, the Q reference signals are respectively Q SL CSI-RSs.

In one embodiment, the Q reference signals comprise a positive integer number of Demodulation Reference Signal(s) (DMRS(s)).

In one embodiment, the Q reference signals respectively comprise a positive integer number of SL DMRS(s).

In one embodiment, the Q reference signals comprise a positive integer number of Synchronization Signal/Physical Broadcast Channel (SS/PBCH) Block(s).

In one embodiment, the Q reference signals comprise a positive integer number of Sidelink Synchronization Signal/Physical Sidelink Broadcast Channel (S-SS/PSBCH) Block(s).

In one embodiment, the first reference signal is one of the Q reference signals, Q being a positive integer greater than 1.

In one embodiment, the first reference signal is one of the Q reference signals, the first reference signal comprises a first sequence, and the first sequence is one of the Q first-type sequences.

In one embodiment, the first reference signal is one of the Q reference signals, a first sequence is used to generate the first reference signal, and the first sequence is one of the Q first-type sequences.

In one embodiment, the first reference signal is acquired after the first sequence sequentially through sequence generation, resource element mapping and wideband symbol generation.

In one embodiment, the first reference signal occupying a positive integer number of RE(s) refers to that the first sequence is mapped onto a positive integer number of RE(s).

In one embodiment, time-frequency resources occupied by the first reference signal comprise a positive integer number of RE(s).

In one embodiment, time-frequency resources occupied by the first reference signal comprise a positive integer number of RE(s) onto which the first sequence is mapped.

In one embodiment, time-frequency resources occupied by the first reference signal comprise N0 RE(s) and N1 RE(s) to which the first sequence is mapped onto, N1 being not greater than the N0, both N1 and N0 being positive integers.

In one embodiment, time-frequency resources occupied by the first reference signal are a Physical Sidelink Shared Channel (PSSCH).

In one embodiment, time-frequency resources occupied by the first reference signal is a unicast PSSCH.

In one embodiment, an RE occupies a multicarrier symbol in time domain, and an RE occupies a subcarrier in frequency domain.

In one embodiment, the multicarrier symbol is an OFDM symbol.

In one embodiment, the multicarrier symbol is a Single-Carrier Frequency-Division Multiple Access (SC-FDMA) symbol.

In one embodiment, the multicarrier symbol is a Discrete Fourier Transform Spread Orthogonal Frequency Division Multiplexing (DFT-S-OFDM) symbol.

In one embodiment, the multicarrier symbol is a Frequency Division Multiple Access (FDMA) symbol.

In one embodiment, the multicarrier symbol is a Filter Bank Multi-Carrier (FBMC) symbol.

In one embodiment, the multicarrier symbol is an Interleaved Frequency Division Multiple Access (IFDMA) symbol.

In one embodiment, the first reference signal is a latest reference symbol in the Q reference signals.

In one embodiment, the Q reference signals are respectively configured with Q latency bounds, and a first latency bound is an earliest bound of the Q latency bounds.

In one embodiment, a target reference signal is any of the Q reference signals, a target latency bound is a latency bound corresponding to the target reference signal among the Q latency bounds, a measurement corresponding to the target reference signal is used to calculate target state information, and a time when the target state information is transmitted is before the target latency bound.

In one embodiment, the target state information is the first CSI, and the target reference signal is the first reference signal.

In one embodiment, any of the Q latency bounds is measured by ms.

In one embodiment, Q2 reference signal(s) of the Q reference signals is(are) earlier than the first latency bound in time, Q2 being not greater than the Q.

In one subembodiment of the above embodiment, the first reference signal is a latest reference signal in the Q2 reference signal(s).

In one subembodiment of the above embodiment, the first reference signal is a reference signal with a largest index in the Q2 reference signal(s).

In one subembodiment of the above embodiment, the first reference signal is an earliest reference signal in the Q2 reference signal(s).

In one embodiment, a first end time is a time when time-domain resources occupied by the first signal are shifted backward in time by a positive integer number of time-domain resource(s).

In one embodiment, the first end time is a positive integer number of time domain resource(s) earlier than time-frequency resources occupied by the first signal.

In one embodiment, the first end time and time-domain resources occupied by the first signal are spaced by a positive integer number of time-domain resource(s).

In one embodiment, the first end time is measured by ms.

In one embodiment, any of the positive integer number of time-domain resource(s) between the first end time and time-domain resources occupied by the first signal is a slot.

In one embodiment, any of the positive integer number of time-domain resource(s) between the first end time and time-domain resources occupied by the first signal is a multicarrier symbol.

In one embodiment, Q3 reference signal(s) in the Q reference signals are earlier than the first time-domain resource in time domain, Q3 being not greater than the Q.

In one subembodiment of the above embodiment, the first reference signal is a latest reference signal in the Q3 reference signal(s).

In one subembodiment of the above embodiment, the first reference signal is a reference signal with a largest index in the Q2 reference signal(s).

In one subembodiment of the above embodiment, the first reference signal is an earliest reference signal in the Q3 reference signal(s).

In one embodiment, a measurement corresponding to the first reference signal comprises time-frequency tracking.

In one embodiment, a measurement corresponding to the first reference signal refers to a coherent-detection-based reception, that is, the first node coherently receives a radio signal on the time-frequency resource block occupied by the first reference signal with the Q first-type sequences comprised in the Q reference signals, and measures energy of the signal obtained after the coherent reception.

In one embodiment, a measurement corresponding to the first reference signal refers to a coherent-detection-based reception, that is, the first node coherently receives a radio signal on the time-frequency resource block occupied by the first reference signal with the first sequence comprised in the first reference signal, and averages received signal energy in time domain to acquire receive power.

In one embodiment, a measurement corresponding to the first reference signal refers to a coherent-detection-based reception, that is, the first node coherently receives a radio signal on the time-frequency resource block occupied by the first reference signal with the first sequence comprised in the first reference signal, and averages received signal energy in time domain and frequency domain to acquire receive power.

In one embodiment, a measurement corresponding to the first reference signal refers to an energy-detection-based reception, that is, the first node senses energy of a radio signal on the time-frequency resource block occupied by a first reference signal and averages it in time to obtain a signal strength.

In one embodiment, a measurement corresponding to the first reference signal refers to that the first node coherently receives a radio signal on the positive integer number of RE(s) occupied by the first reference signal with the first sequence comprised in the first reference signal to acquire channel quality on the time-frequency resource block occupied by the first reference signal.

In one embodiment, a measurement corresponding to the first reference signal refers to a blind-detection-based reception, that is, the first node receives a signal on the time-frequency resource block occupied by the first reference signal and performs a decoding operation, and determines whether the decoding is correct according to a CRC bit.

In one embodiment, a measurement corresponding to the first reference signal is used to calculate the first CSI.

In one embodiment, a measurement corresponding to the first reference signal is used to determine the first CSI out of a CSI list, and the first CSI is one of multiple CSIs comprised in the CSI list.

In one embodiment, the first Channel State Information is a CSI.

In one embodiment, the first Channel State Information is an SL CSI.

In one embodiment, the first CSI comprises a Channel Quality Indicator (CQI).

In one embodiment, the first CSI comprises an SL CQI.

In one embodiment, the first CSI comprises a Rank Indicator (RI).

In one embodiment, the first CSI comprises an SL RI.

In one embodiment, the first CSI comprises a Precoding Matrix Indicator (PMI).

In one embodiment, the first CSI comprises a CSI-RS Resource Indicator (CRI).

In one embodiment, the first CSI comprises an SS/PBCH Block Resource Indicator (SSBRI).

In one embodiment, the first CSI comprises a Layer Indicator (LI).

In one embodiment, the first CSI comprises Layer 1-Reference Signal Receiving Power (L1-RSRP).

In one embodiment, the first CSI comprises a Layer 1-Signal-to-Interference plus Noise Ratio (L1-SINR).

In one embodiment, the first CSI comprises a CQI and an RI.

In one embodiment, measurements performed on Q reference signals are respectively used to calculate Q1 CSI(s), Q1 being a positive integer not greater than the Q.

In one embodiment, Q1 is less than the Q.

In one embodiment, Q1 is equal to the Q.

In one embodiment, any of the Q1 CSIs is one of the multiple CSIs comprised in the CSI list.

In one embodiment, a measurement corresponding to any of Q reference signals is used to calculate a CSI.

In one embodiment, a measurement corresponding to any of Q reference signals is used to calculate one of the Q1 CSIs.

In one embodiment, the measurement corresponding to any of Q reference signals comprises time-frequency tracking.

In one embodiment, the measurement corresponding to any of Q reference signals comprises a coherent-detection-based reception.

In one embodiment, the measurement corresponding to any of Q reference signals comprises an energy-detection-based reception.

In one embodiment, the first signal is a baseband signal.

In one embodiment, the first signal is a radio-frequency signal.

In one embodiment, the first signal is a radio signal.

In one embodiment, the first signal is transmitted on a PSSCH.

In one embodiment, the first signal is transmitted on a Physical Uplink Shared CHannel (PUSCH).

In one embodiment, the first signal comprises all or part of a higher-layer signaling.

In one embodiment, the first signal comprises all or part of a Multimedia Access Control (MAC) layer signal.

In one embodiment, the first signal comprises a MAC Control Element (CE).

In one embodiment, the first signal comprises one or multiple fields in a MAC CE.

In one embodiment, the first signal comprises a MAC Protocol Data Unit (PDU).

In one embodiment, the first signal comprises one or multiple MAC subPDUs in a MAC PDU.

In one embodiment, the first signal comprises all or part of a Radio Resource Control (RRC) layer signal.

In one embodiment, the first signal comprises one or multiple fields in an RRC Information Element (IE).

In one embodiment, the first signal comprises one or multiple fields in a PHY-layer signaling.

In one embodiment, the first signal comprises the first CSI.

In one embodiment, the first signal comprises an index of the first CSI in the CSI list.

In one embodiment, the first signal comprises a series of Q CSIs, and the first CSI is one of the series of Q CSIs.

In one embodiment, indexes of Q CSIs in the CSI list are respectively Q first-type indexes.

In one embodiment, the first signal comprises the Q first-type indexes, and any of the Q first-type indexes is an index of one of the Q CSIs in the CSI list.

In one embodiment, the Q first-type indexes are arranged in order in the first signal.

In one embodiment, measurements corresponding to the Q reference signals are respectively used to calculate a series of Q CSIs.

In one embodiment, the first CSI is a field in the MAC CE comprised in the first signal.

In one embodiment, the first CSI is multiple fields in the MAC CE comprised in the first signal.

In one embodiment, the first CSI is a MAC subPDU in the MAC PDU comprised in the first signal.

In one embodiment, the first CSI is multiple MAC subPDUs in the MAC PDU comprised in the first signal.

In one embodiment, the first signal comprises Q MAC subPDUs, and the Q MAC subPDUs respectively carry the Q CSIs.

In one embodiment, the first signal comprises Q MAC subPDUs, and the Q MAC subPDUs respectively carry the Q first-type indexes.

In one embodiment, the first signal comprises a MAC CE, the MAC CE in the first signal comprises multiple fields, and the multiple fields in the MAC CE comprised in the first signal respectively carry the Q CSIs.

In one embodiment, the first signal comprises a MAC CE, the MAC CE in the first signal comprises multiple fields, and the multiple fields in the MAC CE comprised in the first signal respectively carry the Q first-type indexes.

In one embodiment, the first signal comprises Q MAC subPDUs, and the Q MAC subPDUs respectively carry the Q CSIs, and the first CSI is carried by one of the Q MAC subPDUs.

In one embodiment, the first signal comprises Q MAC subPDUs, the Q MAC subPDUs respectively carry the Q first-type indexes, and an index of the first CSI in the CSI list is carried by one of the Q MAC subPDUs.

In one embodiment, the first signal comprises a MAC CE, the MAC CE in the first signal comprises multiple fields, and the multiple fields in the MAC CE comprised in the first signal respectively carry the Q CSIs, and the first CSI is carried by one of the multiple fields in the MAC CE comprised in the first signal.

In one embodiment, the first signal comprises a MAC CE, the MAC CE in the first signal comprises multiple fields, and the multiple fields in the MAC CE comprised in the first signal respectively carry the Q first-type indexes, and an index of the first CSI in the CSI list is carried by one of the multiple fields in the MAC CE comprised in the first signal.

In one embodiment, a first bit block comprises a positive integer number of bit(s), and the first signal comprises all or partial bit(s) in the first bit block.

In one embodiment, a first bit block is used to generate the first signal, and the first bit block comprises a positive integer number of bit(s).

In one embodiment, the first bit block comprises a positive integer number of bit(s), and all or partial bit(s) of the positive integer number of bit(s) is(are) used to generate the first signal.

In one embodiment, the first bit block comprises one CW.

In one embodiment, the first bit block comprises one CB.

In one embodiment, the first bit block comprises one CBG.

In one embodiment, the first bit block comprises one TB.

In one embodiment, the first signal is acquired after all or partial bits of the first bit block sequentially through transport block-level Cyclic Redundancy Check (CRC) attachment, Code Block Segmentation, code block-level CRC attachment, Channel Coding, Rate Matching, Code Block Concatenation, Scrambling, Modulation, Layer Mapping, Antenna Port Mapping, Mapping to Physical Resource Blocks, Baseband Signal Generation, Modulation and Upconversion.

In one embodiment, the first signal is an output after the first bit block is sequentially subjected to a modulation mapper, a layer mapper, precoding, a resource element mapper, and multi-carrier symbol generation.

In one embodiment, the channel coding is based on a polar code.

In one embodiment, the channel coding is based on a Low-density Parity-Check (LDPC) code.

In one embodiment, only the first bit block is used to generate the first signal.

In one embodiment, there exists a bit block other than the first bit block being used to generate the first signal.

In one embodiment, the candidate type group comprises a plurality of candidate types.

In one embodiment, the candidate type group comprises the first candidate type and the second candidate type.

In one embodiment, the first candidate type is one of the plurality of candidate types comprised in the candidate type group.

In one embodiment, the second candidate type is one of the plurality of candidate types comprised in the candidate type group.

In one embodiment, a first candidate type and a second candidate type are respectively two of the positive integer number of types comprised in the candidate type group.

In one embodiment, the first candidate type is one of the plurality of candidate types comprised in the candidate type group; the second candidate type is one of the plurality of candidate types comprised in the candidate type group.

In one embodiment, any of the plurality of candidate types comprised in the candidate type group is a propagation mode.

In one embodiment, any of the plurality of candidate types comprised in the candidate type group is Unicast.

In one embodiment, any of the plurality of candidate types comprised in the candidate type group is Groupcast.

In one embodiment, any of the plurality of candidate types comprised in the candidate type group is Broadcast.

In one embodiment, the plurality of candidate types comprised in the candidate type group comprise Unicast, Groupcast and Broadcast.

In one embodiment, the candidate type group comprises three candidate types, and the three candidate types are respectively Unicast, Groupcast and Broadcast.

In one embodiment, the first candidate type is Unicast and the second candidate type is Groupcast.

In one embodiment, the first candidate type is Unicast and the second candidate type is Broadcast.

In one embodiment, the first candidate type is Groupcast and the second candidate type is Broadcast.

In one embodiment, any of the plurality of candidate types comprised in the candidate type group carries a destination identifier.

In one embodiment, a destination identifier carried by the first candidate type is different from a destination identifier carried by the second candidate type.

In one embodiment, a destination identifier carried by the first candidate type is a Unicast identifier, and a destination identifier carried by the second candidate type is a Groupcast identifier.

In one embodiment, a destination identifier carried by the first candidate type is a Unicast identifier, and a destination identifier carried by the second candidate type is a Broadcast identifier.

In one embodiment, a destination identifier carried by the first candidate type is a Groupcast identifier, and a destination identifier carried by the second candidate type is a Broadcast identifier.

In one embodiment, a target candidate type is any of the plurality of candidate types comprised in the candidate type group, the target candidate type comprises a first field, and the first field is used to indicate the target candidate type out of the plurality of candidate types comprised in the candidate type group.

In one embodiment, the first target candidate type is the first candidate type.

In one embodiment, the first target candidate type is the second candidate type.

In one embodiment, a value indicated by the first field comprised in the first candidate type is different from a value indicated by the first field comprised in the second candidate type.

In one embodiment, a target candidate type is any of the plurality of candidate types comprised in the candidate type group, the target candidate type comprises a first field and a destination identifier, and the first field is used for a type of the destination identifier carried by the target candidate type.

In one embodiment, the first field is set to “1”, a type of the destination identifier carried by the target candidate type is Unicast identifier, and the target candidate type is the first candidate type.

In one embodiment, the first field is set to “2”, a type of the destination identifier carried by the target candidate type is Groupcast identifier, and the target candidate type is the second candidate type.

In one embodiment, the first field is set to “3”, a type of the destination identifier carried by the target candidate type is Broadcast identifier, and the target candidate type is the second candidate type.

In one embodiment, any of the plurality of candidate types comprised in the candidate type group is a bit string.

In one embodiment, any of the plurality of candidate types comprised in the candidate type group is a bit string arranged in octets.

In one embodiment, any of the plurality of candidate types comprised in the candidate type group comprises at least one parameter field.

In one embodiment, any of the plurality of candidate types comprised in the candidate type group is a MAC CE.

In one embodiment, any of the plurality of candidate types comprised in the candidate type group is a MAC PDU.

In one embodiment, any of the plurality of candidate types comprised in the candidate type group is a MAC subPDU.

In one embodiment, at least one of the plurality of candidate types comprised in the candidate type group is a MAC Segment Data Unit (SDU).

In one embodiment, a number of bit(s) comprised in the first candidate type is different from a number of bit(s) comprised in the second candidate type.

In one embodiment, at least one parameter field comprised in the first candidate type is different from at least one parameter field comprised in the second candidate type.

In one embodiment, one of the positive integer number of parameter field(s) comprised in the first candidate type is different from any of the positive integer number of parameter field(s) comprised in the second candidate type.

In one embodiment, an arrangement order of the positive integer number of parameter field(s) comprised in the first candidate type is different from an arrangement order of the positive integer number of parameter field(s) comprised in the second candidate type.

In one embodiment, both the first candidate type and the second candidate type are MAC CEs, and at least one parameter field comprised in the first candidate type is different from at least one parameter field comprised in the first candidate type.

In one embodiment, both the first candidate type and the second candidate type are MAC subPDUs, and at least one parameter field comprised in the first candidate type is different from at least one parameter field comprised in the first candidate type.

In one embodiment, the first candidate type is a MAC CE, and the second candidate type is a MAC PDU.

In one embodiment, the first candidate type is one MAC CE, and the second candidate type is multiple MAC CEs.

In one embodiment, the first candidate type only comprises one MAC subPDU, and the second candidate type comprises multiple MAC subPDUs.

In one embodiment, the first candidate type is a MAC CE, and the second candidate type is a MAC SDU.

In one embodiment, a MAC subheader comprised in the first candidate type is different from a MAC subheader comprised in the second candidate type.

In one embodiment, both the first candidate type and the second candidate type are MAC subPDUs, and a MAC subheader of the first candidate type is different from a MAC subheader of the second candidate type.

In one embodiment, the target receiver of the first signal is a communication node.

In one embodiment, a communication node is a UE.

In one embodiment, a communication node is a relay.

In one embodiment, a communication node is a base station.

In one embodiment, a communication node is assigned a unique Link Layer IDentifier.

In one embodiment, during a life cycle of a PC5 unicast link, a communication node assigns a PC5Link Identifier by itself, and the PC5 Link Identifier uniquely identifies a PC5 Unicast link.

In one embodiment, a communication node has a Layer-2 IDentifier.

In one embodiment, a communication node has an Application Layer identifier and a Layer-2 identifier.

In one embodiment, the first signal carries a destination identifier, and the destination identifier carried by the first signal is used to identify the target receiver of the first signal.

In one embodiment, the two target receivers of the first signal are two communication nodes.

In one embodiment, one of the two communication nodes is a UE.

In one embodiment, one of the two communication nodes is a relay.

In one embodiment, each of the two communication nodes is a UE.

In one embodiment, the two target receivers of the first signal are assigned two link layer identifiers.

In one embodiment, the two target receivers of the first signal respectively assign two PC5 link layer identifiers by themselves.

In one embodiment, the two target receivers of the first signal have different layer-2 identifiers.

In one embodiment, the two target receivers of the first signal have different application layer identifiers.

In one embodiment, the two target receivers of the first signal have different application layer identifiers, and the two target receivers of the first signal have different layer-2 identifiers.

In one embodiment, the type of the first signal is one of the first candidate type or the second candidate type.

In one embodiment, when the type of the first signal is the first candidate type, the first signal comprises only a CSI corresponding to a target receiver of the first signal, and the target receiver of the first signal is a transmitter of the Q reference signals.

In one embodiment, when the type of the first signal is the first candidate type, the first signal comprises only a CSI corresponding to a target receiver of the first signal, and the target receiver of the first signal is the second node in the present application.

In one embodiment, when the type of the first signal is the second candidate type, the first signal comprises a CSI corresponding to at least two target receivers of the first signal, and the two target receivers of the first signal comprise a transmitter of the Q reference signals.

In one embodiment, when the type of the first signal is the second candidate type, the first signal comprises a CSI of at least two target receivers of the first signal, and the two target receivers of the first signal comprise the second node in the present application.

In one embodiment, when the type of the first signal is the first candidate type, the first signal comprises only a CSI corresponding to a target receiver of the first signal; when the type of the first signal is the second candidate type, the first signal comprises CSIs corresponding to X target receivers of the first signal, X being a positive integer greater than 1.

In one embodiment, when the type of the first signal is the first candidate type, the first signal comprises only a CSI corresponding to a target receiver of the first signal, and the target receiver of the first signal is a transmitter of the Q reference signals; when the type of the first signal is the second candidate type, the first signal comprises CSIs corresponding to X target receivers of the first signal, and the X target receivers of the first signal comprise at least one transmitter of the Q reference signals, X being a positive integer greater than 1.

In one embodiment, when the type of the first signal is the first candidate type, the first signal comprises only a CSI corresponding to a target receiver of the first signal, and the target receiver of the first signal is the second node; when the type of the first signal is the second candidate type, the first signal comprises CSIs corresponding to X target receivers of the first signal, and the X target receivers of the first signal comprise the second node, X being a positive integer greater than 1.

In one embodiment, when the type of the first signal is the first candidate type, the first signal comprises only a CSI corresponding to a target receiver of the first signal, the CSI corresponding to a target receiver of the first signal is the first CSI, and the target receiver of the first signal is a transmitter of the Q reference signals; when the type of the first signal is the second candidate type, the first signal comprises CSIs corresponding to X target receivers of the first signal, and the X target receivers of the first signal comprise at least one transmitter of the Q reference signals, X being a positive integer greater than 1.

In one embodiment, when the type of the first signal is the first candidate type, the first signal comprises only a CSI corresponding to a target receiver of the first signal, the CSI corresponding to a target receiver of the first signal is the first CSI, and the target receiver of the first signal is the second node; when the type of the first signal is the second candidate type, the first signal comprises CSIs corresponding to X target receivers of the first signal, and the X target receivers of the first signal comprise the second node, X being a positive integer greater than 1.

In one embodiment, the first signal comprises Y CSIs, Y being a positive integer greater than 1, and the first CSI is one of the Y CSIs; when the type of the first signal is the first candidate type, each of the Y CSIs in the first signal is a CSI corresponding to a target receiver of the first signal, and the target receiver of the first signal is a transmitter of the Q reference signals; when the type of the first signal is the second candidate type, the Y CSIs in the first signal are CSIs corresponding to X target receivers of the first signal, and the X target receivers of the first signal comprise at least one transmitter of the Q reference signals, X being a positive integer greater than 1, Y being not greater than the X.

In one embodiment, the first signal comprises Y CSIs, Y being a positive integer greater than 1, and the first CSI is one of the Y CSIs; when the type of the first signal is the first candidate type, each of the Y CSIs in the first signal is a CSI corresponding to a target receiver of the first signal, and the target receiver of the first signal is the second node; when the type of the first signal is the second candidate type, the Y CSIs in the first signal are CSIs corresponding to X target receivers of the first signal, and the X target receivers of the first signal comprise the second node, X being a positive integer greater than 1, Y being not greater than the X.

In one embodiment, Y is equal to the X.

In one embodiment, Y is greater than the X.

In one embodiment, when the type of the first signal is the first candidate type, the first signal comprises a CSI; and when the type of the first signal is the second candidate type, the first signal comprises multiple CSIs.

In one embodiment, when the type of the first signal is the first candidate type, the first signal comprises a CSI, and the CSI is the first CSI; when the type of the first signal is the second candidate type, the first signal comprises multiple CSIs, and the first CSI is one of the multiple CSIs.

In one embodiment, when the type of the first signal is the first candidate type, the first signal comprises multiple CSIs, and the multiple CSIs are for the target receiver of the first signal; and when the type of the first signal is the second candidate type, the first signal comprises multiple CSIs, and the multiple CSIs are for at least two target receivers of the first signal.

In one embodiment, when the type of the first signal is the first candidate type, the first signal comprises multiple CSIs, and the multiple CSIs are for the target receiver of the first signal; when the type of the first signal is the second candidate type, the first signal comprises multiple CSIs, and the multiple CSIs are respectively for multiple target receivers of the first signal.

In one embodiment, the candidate type group comprises a third candidate type; when the type of the first signal is the first candidate type, the first signal comprises multiple CSIs; when the type of the first signal is the second candidate type, the first signal comprises multiple CSIs; when the type of the first signal is the third candidate type, the first signal only comprises one CSI.

In one embodiment, the type of the first signal is used to determine the first reference signal out of the Q reference signals.

In one embodiment, the type of the first signal is used to determine an index of the first reference signal in the Q reference signals.

In one embodiment, when the type of the first signal is the first candidate type, the first reference is any of the Q reference signals; when the type of the first signal is the second candidate type, the first reference signal is a latest reference signal in time domain among the Q reference signals.

In one embodiment, when the type of the first signal is the first candidate type, the first reference is any of the Q reference signals; when the type of the first signal is the second candidate type, the first reference signal is a reference signal occupying most time-frequency resources among the Q reference signals.

In one embodiment, when the type of the first signal is the first candidate type, the first reference signal is a reference signal corresponding to an index indicated by the second signaling among the Q reference signals; when the type of the first signal is the second candidate type, the first reference signal is a latest reference signal in time domain among the Q2 reference signals.

### Embodiment 2

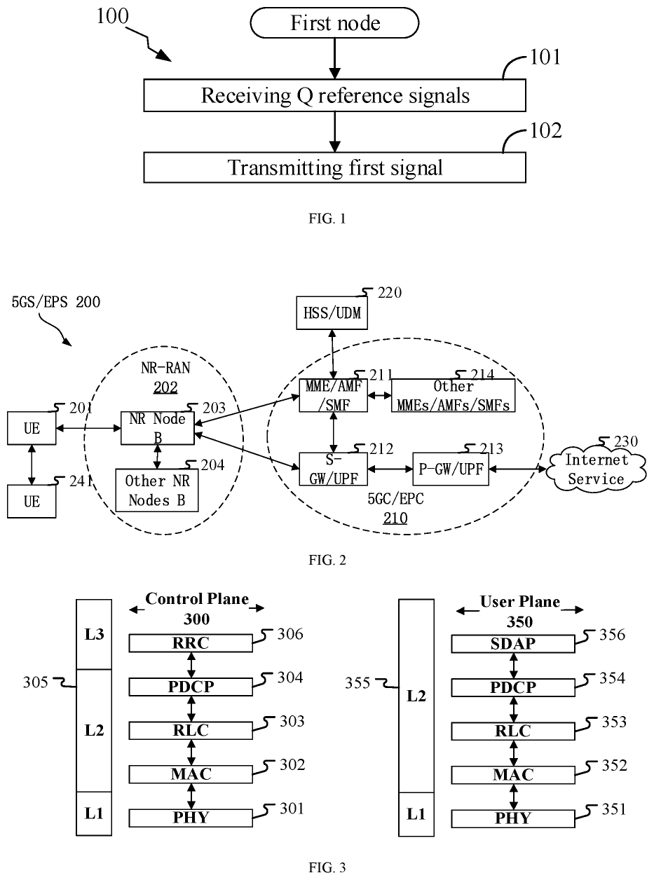

Embodiment 2 illustrates a schematic diagram of a network architecture according to the present application, as shown in FIG. 2. FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN networks, examples of gNB203 include satellites, aircrafts, or ground base stations relayed through satellites. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application comprises the UE 201.

In one embodiment, the second node in the present application comprises the UE 241.

In one embodiment, the UE in the present application comprises the UE 201.

In one embodiment, the UE in the present application comprises the UE 241.

In one embodiment, receivers of the Q reference signals in the present application comprise the UE 201.

In one embodiment, transmitters of the Q reference signals in the present application comprise the UE 241.

In one embodiment, a transmitter of the first signal in the present application comprises the UE 201.

In one embodiment, a receiver of the first signal in the present application comprises the UE 241.

In one embodiment, a transmitter of the first signaling in the present application comprises the UE 201.

In one embodiment, a receiver of the first signaling in the present application comprises the UE 241.

In one embodiment, a transmitter of the second signaling in the present application comprises the UE 201.

In one embodiment, a receiver of the second signaling in the present application comprises the UE 241.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE or RSU in V2X, vehicle equipment or On-Board Communication Unit) and a second node (gNB, UE or RSU in V2X, vehicle equipment or On-Board Communication Unit), or between two UEs is represented by three layers, which are respectively layer 1, layer 2 and layer 3. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection and provides support for handover of a first node between second nodes. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel. The MAC sublayer 302 is also responsible for allocating between first nodes various radio resources (i.e., resource block) in a cell. The MAC sublayer 302 is also responsible for HARQ operations. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 305, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the Q reference signals in the present application are generated by the PHY 301.

In one embodiment, the first signal in the present application is generated by the MAC sublayer 302.

In one embodiment, the first signal in the present application is transmitted to the PHY 301 via the MAC sublayer 302.

In one embodiment, the first signaling in the present application is generated by the RRC sublayer 306.

In one embodiment, the first signaling in the present application is transmitted to the PHY 301 via the MAC sublayer 302.

In one embodiment, the second signaling in the present application is generated by the PHY 301.

In one embodiment, the second signaling in the present application is generated by the MAC sublayer 302.

### Embodiment 4

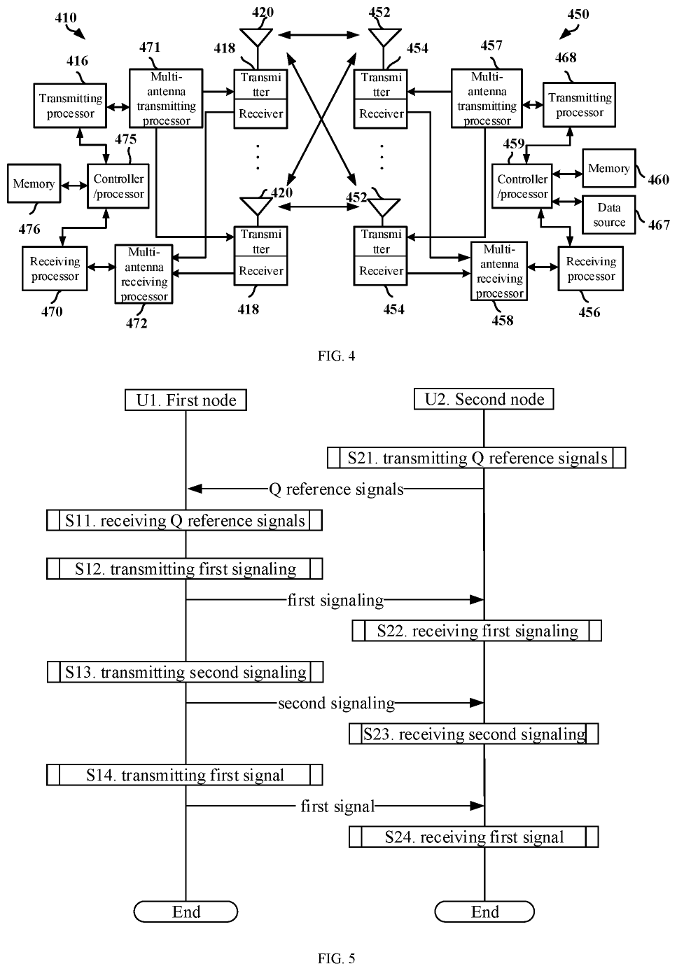

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives Q reference signals, Q being a positive integer greater than 1; and transmits a first signal, the first signal comprises a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, the second communication device 450 comprises a memory that stores a computer readable instruction program. The computer readable instruction program generates an action when executed by at least one processor. The action includes: receiving Q reference signals, Q being a positive integer greater than 1; and transmitting a first signal, the first signal comprising a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits Q reference signals, Q being a positive integer greater than 1; and receives a first signal, the first signal comprises a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, the first communication device 410 comprises a memory that stores a computer readable instruction program. The computer readable instruction program generates an action when executed by at least one processor. The action includes: transmitting Q reference signals, Q being a positive integer greater than 1; and receiving a first signal, the first signal comprising a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, at least one of the antenna 452, the receiver 454, the multi-antenna receiving processor 458, the receiving processor 456, the controller/processor 459, the memory 460, or the data source 467 is used to receive Q reference signals in the present application.

In one embodiment, at least one of the antenna 452, the transmitter 454, the multi-antenna transmitting processor 458, the transmitting processor 468, the controller/processor 459, the memory 460, or the data sources 467 is used to transmit a first signal in the present application.

In one embodiment, at least one of the antenna 452, the transmitter 454, the multi-antenna transmitting processor 458, the transmitting processor 468, the controller/processor 459, the memory 460, or the data sources 467 is used to transmit a first signaling in the present application.

In one embodiment, at least one of the antenna 452, the transmitter 454, the multi-antenna transmitting processor 458, the transmitting processor 468, the controller/processor 459, the memory 460, or the data sources 467 is used to transmit a second signaling in the present application.

In one embodiment, at least one of the antenna 420, the transmitter 418, the multi-antenna transmitting processor 471, the transmitting processor 416, the controller/processor 475, or the memory 476 is used to transmit Q reference signals in the present application.

In one embodiment, at least one of the antenna 420, the receiver 418, the multi-antenna receiving processor 472, the receiving processor 470, the controller/processor 475, or the memory 476 is used to receive a first signal in the present application.

In one embodiment, at least one of the antenna 420, the receiver 418, the multi-antenna receiving processor 472, the receiving processor 470, the controller/processor 475, or the memory 476 is used to receive a first signaling in the present application.

In one embodiment, at least one of the antenna 420, the receiver 418, the multi-antenna receiving processor 472, the receiving processor 470, the controller/processor 475, or the memory 476 is used to receive a second signaling in the present application.

### Embodiment 5

Embodiment 5 illustrates a flowchart of radio signal transmission according to one embodiment in the present application, as shown in FIG. 5. In FIG. 5, a first node U1 and a second node U2 are in communications via an air interface.

The first node U1 receives Q reference signals in step S11; transmits a first signaling in step S12; transmits a second signaling in step S13; and transmits a first signal in step S14.

The second node U2 transmits Q reference signals in step S21; receives a first signaling in step S22; receives a second signaling in step S23; and receives a first signal in step S24.

In Embodiment 5, Q is a positive integer greater than 1; the first signal comprises a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal; the first signaling indicates the type of the first signal; when the type of the first signal is the second candidate type, the first signal comprises a series of M CSIs, M being a positive integer greater than 1; the Q reference signals are transmitted by a second node; the second signaling indicates an index m of a CSI transmitted to the second node U2 in the first signal; the first CSI is an m-th CSI among the series of M CSIs.

In one embodiment, when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

In one embodiment, when the type of the first signal is the first candidate type, the first signaling indicates the first reference signal.

In one embodiment, when the type of the first signal is the first candidate type, the first signal comprises a series of Q CSIs; measurements corresponding to the Q reference signals are respectively used to calculate the series of Q CSIs, and the first CSI is not the last CSI among the series of Q CSIs.

In one embodiment, the first signaling comprises a physical-layer signaling.

In one embodiment, the first signaling comprises Sidelink Control Information (SCI).

In one embodiment, the first signaling comprises a higher-layer signaling.

In one embodiment, the first signaling is a MAC layer signaling.

In one embodiment, the first signaling is a MAC subheader.

In one embodiment, the first signaling is a MAC subheader, and the first signal is a MAC CE.

In one embodiment, the first signaling explicitly indicates the type of the first signal.

In one embodiment, the first signaling implicitly indicates the type of the first signal.

In one embodiment, the first signaling indicates time-frequency resources occupied by the first signal.

In one embodiment, when the type of the first signal is the first candidate type, the first reference signal is a reference signal transmitted at latest among the Q reference signals; when the type of the first signal is the second candidate type, the first reference signal is not a reference signal transmitted at latest among the Q reference signals.

In one embodiment, when the type of the first signal is the third candidate type, the first reference signal is a reference signal transmitted at latest among the Q reference signals.

In one embodiment, when the type of the first signal is the first candidate type, the first signaling indicates the first reference signal.

In one embodiment, when the type of the first signal is the first candidate type, the first signaling indicates time-frequency resources occupied by the first reference signal.

In one embodiment, when the type of the first signal is the first candidate type, the first signaling indicates a PSSCH comprising the first reference signal.

In one embodiment, when the type of the first signal is the first candidate type, the first signaling indicates an antenna port of the first reference signal.

In one embodiment, when the type of the first signal is the first candidate type, the first signaling indicates an index of the first reference signal among the Q reference signals.

In one embodiment, the first signal comprises an original identifier and a destination identifier.

In one embodiment, the original identifier in the first signaling is used to identify a transmitter of the first signaling.

In one embodiment, the original identifier in the first signaling is used to identify the first node U1.

In one embodiment, the destination identifier in the first signaling is used to identify a target receiver of the first signaling.

In one embodiment, the destination identifier in the first signaling is used to identify the second node U2.

In one embodiment, when the type of the first signal is the first candidate type, the destination identifier in the first signaling is used to identify a target receiver of the first signal.

In one embodiment, when the type of the first signal is the second candidate type, the destination identifier in the first signaling is used to identify at least two target receivers of the first signal.

In one embodiment, an original identifier in the first signaling comprises 8 bits.

In one embodiment, a destination identifier in the first signaling comprises 16 bits.

In one embodiment, an original identifier in the first signaling is most significant 8 bits in the layer-2 identifier.

In one embodiment, a destination identifier in the first signaling is most significant 16 bits in the layer-2 identifier.

### Embodiment 6

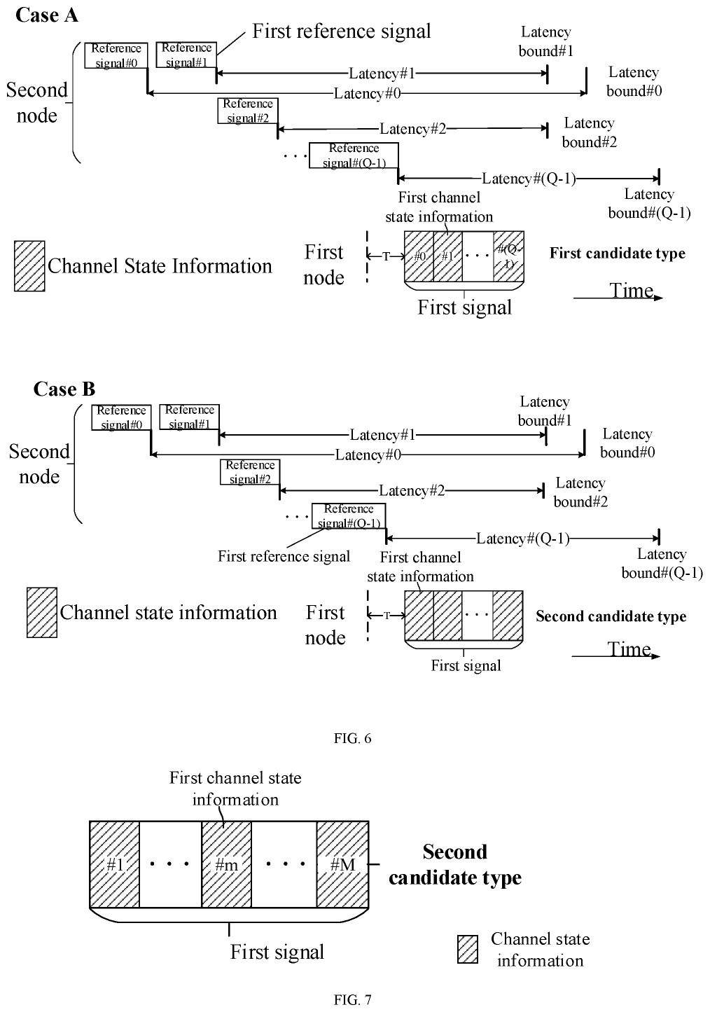

Embodiment 6 illustrates a schematic diagram of relations among Q reference signals and a first signal according to one embodiment of the present application, as shown in FIG. 6. In FIG. 6, the unfilled rectangle represents one of Q reference signals in the present application, and the slash-filled rectangle represents a CSI in a first signal in the present application.

In case A of embodiment 6, the type of the first signal is the first candidate type, the first signal comprises a series of Q CSIs, and measurements corresponding to the Q reference signals are respectively used to calculate a series of Q CSIs; in case B of embodiment 6, the type of the first signal is the second candidate type, the first reference signal is a reference signal transmitted at latest among the Q reference signals.

In one embodiment, when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

In one embodiment, times for receiving the Q reference signals are earlier than the first end time.

In one embodiment, time-frequency resources occupied by the first signal are earlier than an earliest latency bound among the Q latency bounds.

In one embodiment, when the type of the first signal is the first candidate type, the first reference signal is an earliest transmitted reference signal among the Q reference signals.

In one embodiment, when the type of the first signal is the first candidate type, the first reference signal is a reference signal occupying largest time-frequency resources among the Q reference signals.

In one embodiment, when the type of the first signal is the second candidate type, the first reference signal is a reference signal transmitted at latest among the Q reference signals, times for receiving the Q reference signals are earlier than the first end time, and time-frequency resources occupied by the first signal are earlier than an earliest latency bound among the Q latency bounds.

In one embodiment, when the type of the first signal is the first candidate type, the first reference signal is not a reference signal transmitted at latest among the Q reference signals, and the first CSI is not a latest CSI among the series of Q CSIs.

In one embodiment, when the type of the first signal is the second candidate type, the first reference signal is a reference signal transmitted at latest among the Q reference signals, and the first CSI is not a latest CSI among the series of Q CSIs.

### Embodiment 7

Embodiment 7 illustrates a schematic diagram of a relation between a first CSI and a first signal according to one embodiment of the present application, as shown in FIG. 7. In FIG. 7, the slash-filled rectangle represents a CSI.

In embodiment 7, the type of the first signal is the second candidate type, and the first signal comprises a series of M CSIs, M being a positive integer greater than 1; the second signaling indicates an index m of a CSI corresponding to the second node in the first signal; the first CSI is an m-th CSI among the series of M CSIs.

In one embodiment, the Q reference signals are transmitted by the second node.

In one embodiment, the second signaling comprises an index m of the series of M CSIs comprised in the first signal by the first CSI.

In one embodiment, the second signaling explicitly indicates an index m of the series of M CSIs comprised in the first signal by the first CSI.

In one embodiment, the second signaling implicitly indicates an index m of the series of M CSIs comprised in the first signal by the first CSI.

In one embodiment, the second signaling is a higher-layer signaling.

In one embodiment, the second signaling is an RRC-layer signaling.

In one embodiment, the second signaling is unicast.

### Embodiment 8

Embodiment 8 illustrates a structure block diagram of a processor in a first node, as shown in FIG. 8. In embodiment 8, a processor 800 in a first node mainly consists of a first receiver 801 and a first transmitter 802.

In one embodiment, the first receiver 801 comprises at least one of the antenna 452, the transmitter/receiver 454, the multi-antenna receiving processor 458, the receiving processor 456, the controller/processor 459, the memory 460 or the data source 467 in FIG. 4 of the present application.

In one embodiment, the first transmitter 802 comprises at least one of the antenna 452, the transmitter/receiver 454, the multi-antenna transmitting processor 457, the transmitting processor 468, the controller/processor 459, the memory 460, or the data source 467 in FIG. 4 of the present application.

In embodiment 8, the first receiver 801 receives Q reference signals, Q being a positive integer greater than 1; the first transmitter 802 transmits a first signal, the first signal comprises a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, the first transmitter 802 transmits a first signaling, the first signaling indicates the type of the first signal.

In one embodiment, when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

In one embodiment, when the type of the first signal is the first candidate type, the first signaling indicates the first reference signal.

In one embodiment, when the type of the first signal is the first candidate type, the first signal comprises a series of Q CSIs; measurements corresponding to the Q reference signals are respectively used to calculate the series of Q CSIs, and the first CSI is not the last CSI among the series of Q CSIs.

In one embodiment, the first transmitter 802 transmits a second signaling; when the type of the first signal is the second candidate type, the first signal comprises a series of M CSIs, M being a positive integer greater than 1; the Q reference signals are transmitted by the second transmitter 901 in the present application; the second signaling indicates an index m of a CSI transmitted to the second node 900 in the present application in the first signal; the first CSI is an m-th CSI among the series of M CSIs.

In one embodiment, the first node 800 is a UE.

In one embodiment, the first node 800 is a relay node.

In one embodiment, the first node 800 is a base station.

### Embodiment 9

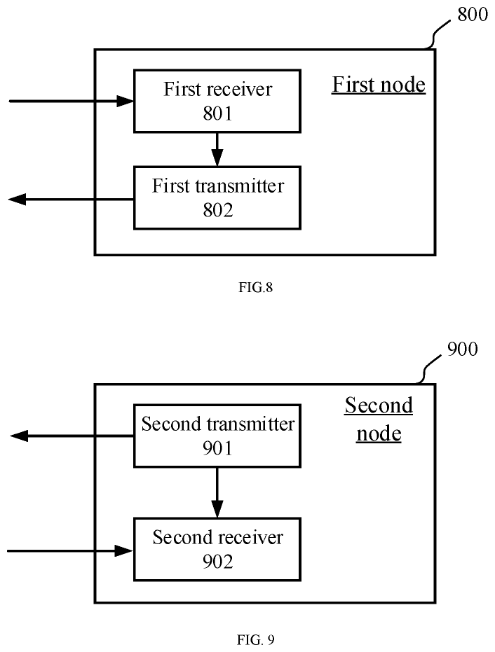

Embodiment 9 illustrates a structure block diagram of a processor in a second node, as shown in FIG. 9. In FIG. 9, a processor 900 in a second node mainly consists of a second transmitter 901 and a second receiver 902.

In one embodiment, the second transmitter 901 comprises at least one of the antenna 420, the transmitter/receiver 418, the multi-antenna transmitting processor 471, the transmitting processor 416, the controller/processor 475 or the memory 476 in FIG. 4 of the present application.

In one embodiment, the second receiver 902 comprises at least one of the antenna 420, the transmitter/receiver 418, the multi-antenna receiving processor 472, the receiving processor 470, the controller/processor 475 or the memory 476 in FIG. 4 of the present application.

In embodiment 9, the second transmitter 901 transmits Q reference signals, Q being a positive integer greater than 1; the second receiver 902 receives a first signal, the first signal comprises a first CSI; among the Q reference signals, only a measurement corresponding to a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

In one embodiment, the second receiver 902 receives a first signaling, the first signaling indicates the type of the first signal.

In one embodiment, when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

In one embodiment, when the type of the first signal is the first candidate type, the first signaling indicates the first reference signal.

In one embodiment, when the type of the first signal is the first candidate type, the first signal comprises a series of Q CSIs; measurements corresponding to the Q reference signals are respectively used to calculate the series of Q CSIs, and the first CSI is not the last CSI among the series of Q CSIs.

In one embodiment, the second receiver 902 receives a second signaling; when the type of the first signal is the second candidate type, the first signal comprises a series of M CSIs, M being a positive integer greater than 1; the Q reference signals are transmitted by the second transmitter 901; the second signaling indicates an index m of a CSI transmitted to the second node 900 in the first signal; the first CSI is an m-th CSI among the series of M CSIs.

In one embodiment, the second node 900 is a UE.

In one embodiment, the second node 900 is a relay node.

In one embodiment, the second node 900 is a base station.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving Q reference signals, Q being a positive integer greater than 1; and
a first transmitter, transmitting a first signal, the first signal comprising first Channel State Information (CSI);
wherein among the Q reference signals, only a measurement corresponding to a first reference signal is used to calculate the first CSI; a type of the first signal is used to determine the first reference signal out of the Q reference signals; a candidate type group comprises a first candidate type and a second candidate type; the type of the first signal is one of the first candidate type or the second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

2. The first node according to claim 1, wherein the first reference signal is one of the Q reference signals, the first reference signal comprises a first sequence, the first sequence is one of Q first-type sequences, and the Q first-type sequences are respectively used to generate the Q reference signals;
or, transmitters of the Q reference signals are a same communication node;
or, the first reference signal is one of the Q reference signals, the first reference signal comprises a first sequence, the first sequence is one of Q first-type sequences, the Q first-type sequences are respectively used to generate the Q reference signals, and transmitters of the Q reference signals are a same communication node.

3. The first node according to claim 1, comprising:
the first transmitter, transmitting a first signaling;
wherein the first signaling indicates the type of the first signal.

4. The first node according to claim 1, wherein the candidate type group comprises a plurality of candidate types, the first candidate type and the second candidate type are two of the plurality of candidate types comprised in the candidate type group.

5. The first node according to claim 1, wherein the candidate type group comprises a plurality of candidate types, and any of the plurality of candidate types comprised in the candidate type group is one of Unicast, Groupcast or Broadcast; the first candidate type is Unicast and the second candidate type is Groupcast, or, the first candidate type is Unicast and the second candidate type is Broadcast, or, the first candidate type is Groupcast and the second candidate type is Broadcast;
or, wherein the candidate type group comprises a plurality of candidate types, any of the plurality of candidate types comprised in the candidate type group carries a destination identifier, and a destination identifier carried by the first candidate type is different from a destination identifier carried by the second candidate type;
or, wherein the candidate type group comprises a plurality of candidate types, any of the plurality of candidate types comprised in the candidate type group is a bit string, and number of bits comprised in the first candidate type is not equal to number of bits comprised in the second candidate type;
or, wherein the candidate type group comprises a plurality of candidate types, any of the plurality of candidate types comprised in the candidate type group comprises at least one parameter field, and at least one parameter field comprised in the first candidate type is different from at least one parameter field comprised in the second candidate type.

6. The first node according to claim 5, wherein both the first candidate type and the second candidate are MAC subPDUs, and at least one parameter field comprised in the first candidate type is different from at least one parameter field comprised in the second candidate type; or, both the first candidate type and the second candidate type are MAC subPDUs, and a MAC subheader comprised in the first candidate type is different from a MAC subheader comprised in the second candidate type.

7. The first node according to claim 1, wherein the first signal carries a destination identifier, and the destination identifier carried by the first signal is used to identify the target receiver of the first signal.

8. The first node according to claim 1, wherein when the type of the first signal is the first candidate type, the first signal comprises only a CSI corresponding to a target receiver of the first signal, and the target receiver of the first signal is a transmitter of the Q reference signals; when the type of the first signal is the second candidate type, the first signal comprises CSIs corresponding to X target receivers of the first signal, and the X target receivers of the first signal comprise at least one transmitter of the Q reference signals, X being a positive integer greater than 1;
or, wherein the first signal comprises Y CSIs, Y being a positive integer greater than 1, and the first CSI is one of the Y CSIs; when the type of the first signal is the first candidate type, each of the Y CSIs in the first signal is a CSI corresponding to a target receiver of the first signal, and the target receiver of the first signal is a transmitter of the Q reference signals; when the type of the first signal is the second candidate type, the Y CSIs in the first signal are CSIs corresponding to X target receivers of the first signal, and the X target receivers of the first signal comprise at least one transmitter of the Q reference signals, X being a positive integer greater than 1, Y being not greater than the X;
or, wherein when the type of the first signal is the first candidate type, the first reference signal is not the reference signal transmitted at latest among the Q reference signals; when the type of the first signal is the second candidate type, the first reference signal is the reference signal transmitted at latest among the Q reference signals.

9. The first node according to claim 8, wherein the type of the first signal is the first candidate type, and the first signaling indicates the first reference signal;
or, the type of the first signal is the first candidate type, and the first signal comprises a series of Q CSIs;
measurements corresponding to the Q reference signals are respectively used to calculate the series of Q CSIs, and the first CSI is not the last CSI among the series of Q CSIs.

10. The first node according to claim 1, comprising:
transmitting a second signaling;
wherein when the type of the first signal is the second candidate type, the first signal comprises a series of M CSIs, M being a positive integer greater than 1; the Q reference signals are transmitted by a second node; the second signaling indicates an index m of a CSI corresponding to the second node in the first signal; the first CSI is an m-th CSI among the series of M CSIs.

11. A second node for wireless communications, comprising:
a second transmitter, transmitting Q reference signals, Q being a positive integer greater than 1; and
a second receiver, receiving a first signal, the first signal comprising a first CSI;
wherein among the Q reference signals, only a measurement performed on a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

12. The second node according to claim 11, comprising:
the second receiver, receiving a first signaling;
wherein the first signaling indicates the type of the first signal.

13. The second node according to claim 11, wherein when the type of the first signal is the first candidate type, the first reference signal is not a reference signal transmitted at latest among the Q reference signals; when the type of the first signal is the second candidate type, the first reference signal is a reference signal transmitted at latest among the Q reference signals.

14. The second node according to claim 13, wherein the type of the first signal is the first candidate type, and the first signaling indicates the first reference signal;
or, the type of the first signal is the first candidate type, and the first signal comprises Q CSIs;
measurements performed on the Q reference signal are respectively used to calculate the Q CSIs, and the first CSI is not the last CSI among the Q CSIs.

15. The second node according to claim 11, comprising:
the second receiver, receiving a second signaling;
wherein when the type of the first signal is the second candidate type, the first signal comprises M CSIs, M being a positive integer greater than 1; the Q reference signals are transmitted by a second node; the second signaling indicates an index m of a CSI corresponding to the second node in the first signal; the first CSI is an m-th CSI among the M CSIs.

16. A method in a first node for wireless communications, comprising:
receiving Q reference signals, Q being a positive integer greater than 1; and
transmitting a first signal, the first signal comprising a first CSI;
wherein among the Q reference signals, only a measurement performed on a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.

17. The method according to claim 16, wherein the first reference signal is one of the Q reference signals, the first reference signal comprises a first sequence, the first sequence is one of Q first-type sequences, and the Q first-type sequences are respectively used to generate the Q reference signals;
or, transmitters of the Q reference signals are a same communication node;
or, the first reference signal is one of the Q reference signals, the first reference signal comprises a first sequence, the first sequence is one of Q first-type sequences, the Q first-type sequences are respectively used to generate the Q reference signals, and transmitters of the Q reference signals are a same communication node.

18. The method according to claim 16, comprising:
the first transmitter, transmitting a first signaling;
wherein the first signaling indicates the type of the first signal.

19. The method according to claim 16, wherein the candidate type group comprises a plurality of candidate types, and any of the positive integer number of type(s) comprised in the candidate type group is one of Unicast, Groupcast or Broadcast; the first candidate type is Unicast and the second candidate type is Groupcast, or, the first candidate type is Unicast and the second candidate type is Broadcast, or, the first candidate type is Groupcast and the second candidate type is Broadcast;
or, wherein the candidate type group comprises a plurality of candidate types, any of the positive integer number of type(s) comprised in the candidate type group carries a destination identifier, and a destination identifier carried by the first candidate type is different from a destination identifier carried by the second candidate type;
or, wherein the candidate type group comprises a plurality of candidate types, any of the positive integer number of type(s) comprised in the candidate type group is a bit string, and number of bits comprised in the first candidate type is not equal to number of bits comprised in the second candidate type;
or, wherein the candidate type group comprises a plurality of candidate types, any of the positive integer number of type(s) comprised in the candidate type group comprises at least one parameter field, and at least one parameter field comprised in the first candidate type is different from at least one parameter field comprised in the second candidate type.

20. A method in a second node for wireless communications, comprising:
transmitting Q reference signals, Q being a positive integer greater than 1; and
receiving a first signal, the first signal comprising a first CSI;
wherein among the Q reference signals, only a measurement performed on a first reference signal is used to calculate the first CSI; a type of the first signal is used to determine the first reference signal out of the Q reference signals; the type of the first signal is a candidate type in a candidate type group; the candidate type group comprises a first candidate type and a second candidate type; when the type of the first signal is the first candidate type, the first signal comprises only a CSI corresponding to a target receiver of the first signal; when the type of the first signal is the second candidate type, the first signal comprises CSIs corresponding to at least two target receivers of the first signal.
